(19) United States
(12) Patent Application Publication
(10) Pub. No.: US 2019/0146462 A1
(43) Pub. Date: May 16, 2019

(54) ROBOTIC INSPECTION SYSTEM WITH DATA TRANSMISSION

(71) Applicant: General Electric Company, Schenectady, NY (US)

(72) Inventors: Huan Tan, Clifton Park, NY (US); Li Zhang, Niskayuna, NY (US); Romano Patrick, Niskayuna, NY (US); Viktor Holovashchenko, Watervliet, NY (US); Charles Burton Theurer, Alplaus, NY (US); John Michael Lizzi, JR., Wilton, NY (US); Arpit Jain, Niskayuna, NY (US); Shiraj Sen, Clifton Park, NY (US); Todd William Danko, Schenectady, NY (US); Kori U. MacDonald, Albany, NY (US)

(21) Appl. No.: 15/809,515

(22) Filed: Nov. 10, 2017

(51) Int. Cl. G05B 19/418; B25J 9/16; G08G 5/00

(52) U.S. Cl. CPC G05B 19/4183; B25J 9/161; G06Q 10/063; G08G 5/0039; B25J 9/1697

(57) ABSTRACT

The present approach relates to streaming data derived from inspection data acquired using one or more robots performing inspections of an asset or assets. Such inspections may be fully or partially automated, such as being controlled by one or more computer-based routines, and may be planned or dynamically altered in response to inputs or requirements associated with an end-user of the inspection data, such as a subscriber to the data in a publication/subscription distribution scheme. Thus, an inspection may be planned or altered based on the data needs or subscription levels of the user or customers.

### BACKGROUND

The subject matter disclosed herein relates to asset inspection, and more specifically to coordinating the inspection of one or more assets by one or more robots.

Various entities may own or maintain different types of assets as part of their operation. Such assets may include physical or mechanical devices, structures, or facilities which may, in some instances, have electrical and/or chemical aspects as well. Such assets may be used or maintained for a variety of purposes and may be characterized as capital infrastructure, inventory, or by other nomenclature depending on the context. For example, assets may include distributed assets, such as a pipeline or an electrical grid as well as individual or discrete assets, such as an airplane, a wind turbine generator, a radio tower, a steam or smoke stack or chimney, a bridge or other structure, a vehicle, and so forth. Assets may be subject to various types of defects (e.g., spontaneous mechanical defects, electrical defects, as well as routine wear-and-tear) that may impact their operation. For example, over time, the asset may undergo corrosion or cracking due to weather or may exhibit deteriorating performance or efficiency due to the wear or failure of component parts.

While inspection using human agents is common, in some circumstances an inspection may be performed or facilitated using an automated mechanism, such as an industrial inspection device that collects data autonomously or semi-autonomously for an asset. By way of example, the robot or drone may move relative to the asset and collect data continuously or at waypoints along the path. However, typically access and/or review of the data, either in a raw or processed form, is delayed as the full data set is generally downloaded at the conclusion of the inspection and subsequently moved to a processing site prior to analysis and/or distribution.

### BRIEF DESCRIPTION

In one embodiment, an asset inspection system is provided. In accordance with this embodiment, the asset inspection system includes one or more robots configured to collect inspection data related to an asset and a data streaming server configured to receive inspection data from the one or more robots and to transmit subscriber-specific inspection data to one or more subscribers. The data streaming server is configured to: for one or more subscribers, dispatch an incoming inspection data feed to a plurality of channels; synchronize the dispatch of the incoming inspection data feed to the plurality of channels based on one or more distribution streams, wherein each distribution stream is specific to at least one subscriber; process the plurality of channels to generate the one or more distribution streams; and distribute the one or more distribution streams to the one or more respective subscribers.

In a further embodiment, a method of distributing inspection data or analytics is provided. In accordance with this embodiment, inspection data related to an asset is acquired. For one or more subscribers, an incoming inspection data feed derived from the acquired inspection data is dispatched to a plurality of channels. The dispatch of the incoming inspection data feed to the plurality of channels is synchronized based on one or more distribution streams. Each distribution stream is specific to at least one subscriber. The plurality of channels is processed to generate the one or more distribution streams. The one or more distribution streams are distributed to the one or more respective sub scribers.

In an additional embodiment, an asset inspection system is provided. In accordance with this embodiment, the asset inspection system includes one or more robots configured to collect inspection data related to an asset and a data streaming server configured to receive inspection data from the one or more robots and to transmit subscriber-specific inspection data to one or more subscribers. The data streaming server is configured to: generate one or more client-specific distribution streams based on the inspection data, wherein each client distribution stream comprises one or more of raw data, pre-processed data, processed data, analyzed data, or a summary or annotated report; receive an instruction from at least one subscriber; and in response to the instruction, propagate instructions causing a change to the distribution stream for the respective client.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an asset inspection system and various types of assets suitable for inspection, in accordance with aspects of the present disclosure;

FIG. 2 is a schematic of a robot of the asset inspection system of FIG. 1, in accordance with aspects of the present disclosure;

FIG. 3 is a block diagram of a processor based system suitable for use with the asset inspection system of FIG. 1, in accordance with aspects of the present disclosure;

FIG. 4 is a schematic illustrating components and operations of an asset system framework, in accordance with aspects of the present disclosure;

FIG. 5 is a schematic illustrating components and operations of a data pre-processing and compression stage, in accordance with aspects of the present disclosure; and

FIG. 6 is a schematic illustrating components and operations of a data transmission stage, in accordance with aspects of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

In accordance with certain implementations of the present approach, data streaming, which may be real-time or with a limited lag, is provided for accessing or viewing inspection data (e.g., industrial, commercial, utility inspection data, environmental surveys or inspections, human activity monitoring) acquired using one or more robots performing inspections. Such inspections may be fully or partially automated, such as being controlled by one or more computer-based routines, and may be planned or dynamically altered in response to inputs or requirements associated with an end-user of the inspection data, such as a subscriber to the data in a publication/subscription distribution scheme. In such a scheme, there may be multiple subscriber or users of the inspection data and they may be affiliated with a different entity than the inspecting entity (e.g., where the inspection is provided as a service to a customer), may be at different levels or subscription tiers with one or different entities (e.g., maintenance, planning, operations, and so forth), and/or may be affiliated with different entities altogether (e.g., an entity responsible for maintaining a piece of infrastructure versus one or more entities that use the infrastructure commercially). Thus, an inspection may be planned or altered based on the data needs or subscription levels of the user or customers, which may reduce or eliminate the acquisition that is not of interest or will not be used and to ensure that a suitable extent and type of inspection data is acquired for a current set of subscribers. Examples of inspection applications include, but are not limited to: engine inspection, pipeline inspection, turbine inspection, generator inspection, healthcare device inspection, and so forth, but may also encompass activities such as crowd monitoring, surveying or monitoring of disaster areas or animal habitats, and so forth.

Such inspection or monitoring activities may be performed using unmanned or robotic devices, such as ground-based mobile robots, including those with legs, wheels, tracks, etc., unmanned aerial vehicles (UAVs), including fixed wing and rotary wing vehicles, unmanned submersible vehicles (USVs), which may swim or move along the floor of the body of liquid, or other autonomously moving vehicles that may be characterized as drones or robots. For simplicity, to the extent the terms “drone” and “robot” are used herein, though it should be appreciated that this terminology is intended to encompass all variations of UAVs, USVs, robotic devices, and so forth that are capable of programmable movement with no or limited human oversight. Such programmable movement can be based on either locally generated path waypoints or guidance or path guidance and waypoints generated by a remote system and communicated to the robot. Thus, as used herein, such devices move during an operational phase or period entirely or primarily without direct human intervention or control and/or with limited human intervention or oversight. In accordance with present approaches, such devices may be operated to move along a flight plan, along which the devices acquire inspection data, such as video or still image data, LIDAR data, acoustic data, spectroscopic data, temperature or pressure data, or other data that can be acquired by sensors or cameras that can be affixed to a device moving along the flight plan and appropriate to the type of monitoring or inspection being performed. The positions and orientations of the sensors can typically be adjusted based on operator judgement and/or the robot's own situational awareness. The sensory information can be collected synchronously or asynchronously. In general, inspections using such robots may be performed on one or more assets including, but not limited to, power generation assets, communication assets, transportation assets, mining or underground pumping assets, manufacture or construction assets and so forth. As noted above, in a subscription data dissemination scheme, the subscribers to a given inspection, their data needs, and/or their subscription type or level may be a factor in establishing or changing a flight plan and/or determining a sensor package to be employed.

As discussed herein, an inspection and data streaming system may incorporate several aspects, including: 1) a robotic platform for data collection, 2) inspection data pre-processing for data streaming, 3) inspection data streaming, 4), on-site inspection analytics after data streaming, and 5) inspection analytics results broadcasting (or other transmission to a specified recipient). The present approach is suitable for streaming inspection data, including video, images, and laser data (any or all of which may constitute large data files or data streams) across different components of an inspection system framework. Data transmission can be seamlessly automated to reduce latency and increase the real-time processing performance.

In accordance with the present approach, data acquired during an inspection performed by a robot or drone may be streamed in a real-time or near real-time manner to one or more reviewers, such as based on a subscription scheme. The reviewers may be affiliated with a different entity than the entity controlling and/or operating the robot or drone, such that the inspection and inspection data are provided commercially as a service to the reviewers (e.g., customers). As noted above and discussed herein, the inspection data may be provided in tiered categories, such as may be suitable for a subscription type service, with different levels or types of reviewers being provided inspection data that has been processed or analyzed to different extents (e.g., raw data, pre-processed data, processed data, analyzed data, and/or summary or annotated reports) and/or at different time offsets that may correspond to the data provided. For example, raw inspection data may be provided near instantaneously or in real-time, whereas annotated inspection data or final or summary report type data may provided after packaging and processing.

Though the phrase “flight plan” is used generally herein, it should be appreciated that this phrase does not necessitate aerial movement, but instead relates to any one-dimensional (1D) (such as along a track), two-dimensional (2D) (such as along a defined or undefined planar route), or three-dimensional (3D) (such as movement in the air, under water, or on a structure in where depth or altitude is also traversable), or four-dimensional (4D) (such as where there are defined temporal aspects that may characterize a velocity, acceleration, or a time on station at a waypoint) path or route along which a drone moves as part of an inspection plan. Thus, a “flight plan” as used herein may be characterized as any 1D, 2D, 3D, or 4D route or path along which device such as a drone or robot is moved to perform a sensor-based inspection of an asset. Such a path may be adaptive, as discussed herein, and may consist of one or more waypoints along which the robot proceeds in an ordered fashion, with the sequence and location of the waypoints defining the path or route. It should be appreciated that such a flight plan may also incorporate not only temporal and/or spatial locations, but also orientation and/or alignment instructions for movement along the path and/or to exhibit at a given waypoint. Thus, the flight plan may also specify parameters such as roll, pitch, and yaw for the drone to exhibit at different points along the flight plan as well as two- or three-dimensional alignment characteristics that may relate to the direction in which a sensor or camera is pointing at a point along the flight plan. Thus, the flight plan may address not only where or when a robot is with respect to an inspection site but, at a given location or waypoint, the direction the robot is facing or otherwise oriented with respect to. Further, even at the same waypoint and orientation, images may be acquired at different magnifications, wavelengths, or other optical parameter such that effectively the image constitutes a different view.

To facilitate explanation and provide useful real-world context, various examples of assets that may be inspected, such as wind turbine generators, radio transmission towers, smokestacks, and so forth, may be provided herein. It should be appreciated however that such examples are provided merely to facilitate explanation, and the present approach is suitable for use with a wide range of other assets and at various other types of sites or monitoring contexts. Thus, the present approach is not intended to be limited to the context of the present examples.

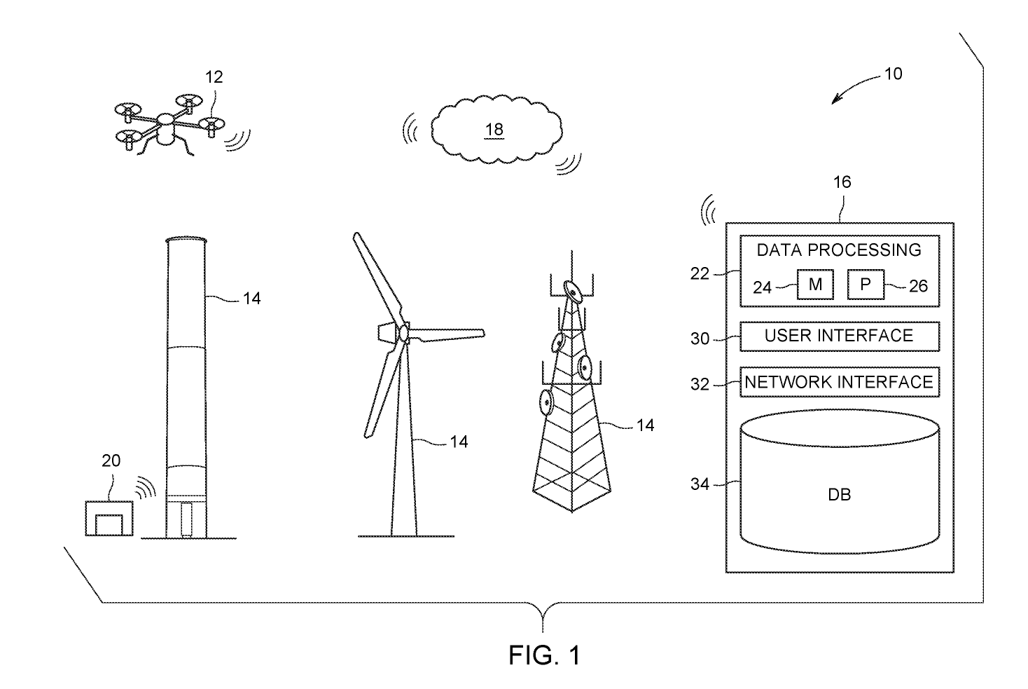

With the preceding in mind, and turning to the figures, FIG. 1 depicts aspects of an inspection system 10 employing one or more robots 12 suitable for inspecting one or more assets 14, such as a wind turbine generator, radio tower, smokestack, or other suitable asset.

In the depicted example a remote server or servers 16, accessible via a cloud 18 (e.g., a network interface for accessing one or more remote servers virtual machines, etc. for storage, computing, or other functionality) are depicted. Such servers 16 may communicate with the one or more robots 12 to coordinate operation of one or more robots 12, such as for inspection of an asset 14. In one embodiment, the robot(s) 12 have onboard cellular or network connectivity and can communicate with the remote server 16 prior to beginning, during, and/or after an inspection. In certain implementations the cellular or network connectivity of the robot(s) 12 allow communication during an inspection, allowing inspection data to be communicated to the remote server 16 and/or allowing the remote server 16 to communicate changes to the flight plan to a given robot 12. Alternatively, changes to the flight plan may be determined by a processor internal to the robot 12, i.e., onboard, such as in the event the robot 12 is operating outside of communication range from the remote server 16.

As shown, in some embodiments, the system may also include a docking station 20 (e.g., robot garage), disposed on or near the asset 14, for short term or long term storage of the robot 12 before and/or after inspection. In some embodiments, the docking station 20 may be in communication with the remote server 16 via the cloud 18. If the robot 12 relies on a battery for power, the docking station 20 may also include a power source for charging the robot's 12 battery.

In the depicted example, the remote server 16 is a remote computing device accessible by the robot(s) 12 via the cloud 18. Though only a single remote server 16 is shown in FIG. 1, it should be understood that the functions performed by the remote server 16 may be performed by multiple remote servers 16 and/or by virtualized instances of a server environment. In the instant embodiment, the remote server 16 includes a data processing system 22, which may include a memory component 24 and a processor 26, for processing data received from the robot 12. As is described in more detail below, in some embodiments, the robot 12 may provide raw data to the remote server 16 for processing. In other embodiments, the robot 12 may pre-process or partially process the data before passing it to the remote server 16. In further embodiments, all of the data processing may be performed by the robot 12.

The remote server(s) 16 are also depicted as including a user interface by which a user may locally or remotely issue instructions or commands to the server(s) 16. Such commands may in turn be acted upon by the remote server 16 to control an aspect of the operation of the robot 12 or to control or change an aspect of the receipt, processing, and/or transmission of data generated by the robot 12. In addition, the remote server(s) 16 are depicted as including a network interface 32 that may be used to communicate with other components of an overall inspection system (such as other servers 16, a robot 12, storage devices, processing components, and so forth) over a local network, a wide area network, the Internet, and so forth.

During an inspection, the robot 12 may send inspection data to the remote server(s) 16 for one or more of processing, storage, or streaming in a real-time or near real-time manner, as discussed in greater detail below. By way of example, videos, images, LIDAR data, depth sensor data, acoustic data, spectroscopic data, or other relevant sensor or camera data acquired by the one or more robots 12 during an inspection may be streamed to one or more subscribers to the data in a raw format, streamed to the one or more subscriber in a processed form, and/or uploaded to a database 34 as acquired or as a batch for subsequent processing or distribution.

In the depicted example, the data processing system 22 and the database 34 are depicted as part of a single or common processor-based system. However, the depicted functionalities, as well as other functionalities discussed herein, may be implemented in a distributed or dispersed manner, with certain aspects being local to the asset 14, to the robot 12, to an operational facility and/or other locations remote from the asset 14. In such distributed implementations, the depicted aspects may still be communicatively linked, such as over one or more network connections.

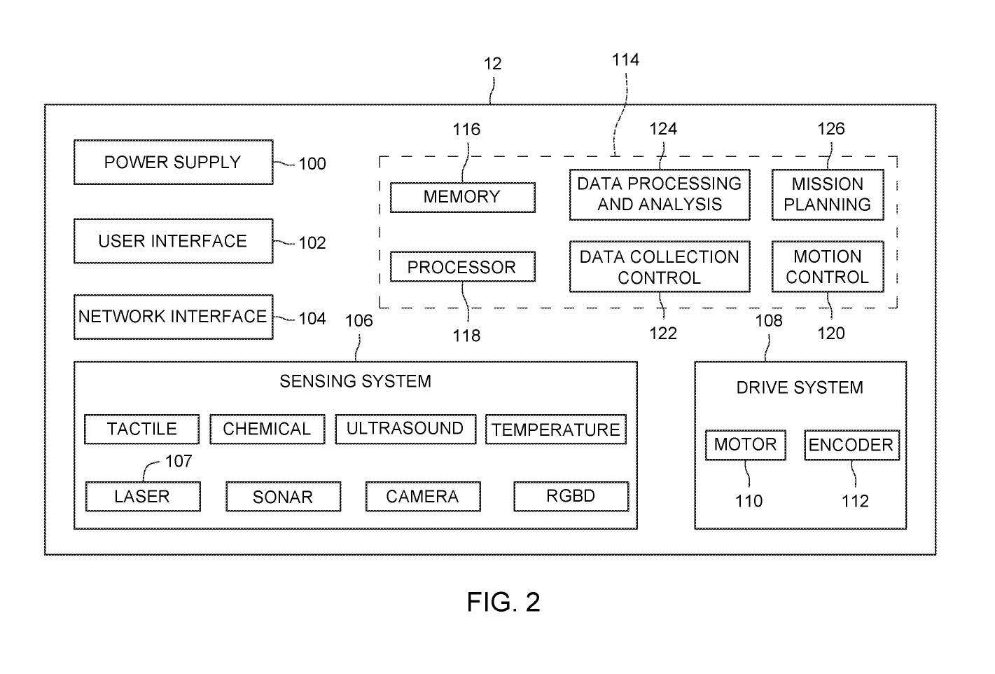

FIG. 2 is a schematic of an embodiment of the robot 12 shown in FIG. 1. It should be understood, however, that other embodiments of the robot 12 are envisaged having additional components, fewer components, and/or different combinations of components. As shown, the robot 12 includes a power supply 100 to provide power for the operation of the robot 12. The power supply 100 may include a replaceable or rechargeable battery, a combustion engine, a generator, and electric motor, a solar panel, a chemical-reaction based power generation system, etc., or some combination thereof.

The robot may include a user interface 102, by which a user may set up or adjust various settings of the robot 12. The user interface may include one or more input devices (e.g., knobs, buttons, switches, dials, etc.) and in some cases may include a display (e.g., a screen, array of LEDs, etc.) for providing feedback to the user.

A network interface 104 enables communication with the remote server 16 via the cloud 18, or other devices (e.g., the docking station 20, a remote controller, a smart phone, a computing device, a tablet, etc.). For example, the network interface 104 may enable communication via a wireless network connection, a wired network connection, cellular data service, Bluetooth, Near Field Communication (NFC), ZigBee, ANT+, or some other communication protocol.

A sensing system 106 may include one or more sensors 107 (e.g., tactile, chemical, ultrasound, temperature, laser, sonar, camera, a red, blue, green, depth (RGB-D) camera, etc.) configured to sense various qualities and collect data during an inspection of an asset.

A drive system 108 may actuate movement of the robot 12 through the air, through a liquid, along a surface, or some combination thereof. As shown, the drive system 108 may include one or more motors 110 and one or more encoders 112. The one or more motors 110 may drive propellers, legs, wheels, tracks, etc. The one or more encoders 112 may sense one or more parameters of the one or more motors 110 (e.g., rotational speed) and provide data to a control system 114.

The control system 114 may include one or more memory components 116 and one or more processors 118. A motion control system 120 may receive a signal from the one or more encoders 112 of the drive system 108 and output a control signal to the one or more motors 110 to control the movement of the robot 12. Similarly, a data collection control system 122 may control the operation of the sensing system 106 and receive data from the sensing system 106. The communication interface between the sensors 107 and the on-board processor 118 may be a standard industrial interface, including parallel bus, serial bus (I2C, SPI), and USB. A data processing and analysis system 124 may receive data collected by the sensing system 106 and process or analyze the collected data. In some embodiments, the data processing and analysis system 124 may process and analyze the data to different extents, as discussed in greater detail below, in accordance with a level or state of data to be streamed to a reviewer. In other embodiments, the data processing and analysis system 124 may perform pre-processing of the data or a partial processing and analysis of the data and then send the data for streaming to a reviewer and/or for transmission to a remote server 16 for the further processing, analysis, and/or streaming. In further embodiments, the robot 12 may stream raw data to a reviewer and/or may send the raw data to a remote server 16.

The control system 114 may also include a mission planning component 126 that may autonomously or in coordination with a remote server 16 generate or update a mission plan and executes the mission plan by coordinating the various other components of the control system 114 and the robot 12. As discussed herein, an aspect of mission planning, either at the level of the remote server 16 or the robot 12, may be taking into account the levels or types of reviewers (e.g., subscribers) who will receive the data and the type or extent of data (e.g., raw data, pre-processed data, processed data, analyzed data, and/or summary or annotated reports) each reviewer is entitled to receive.

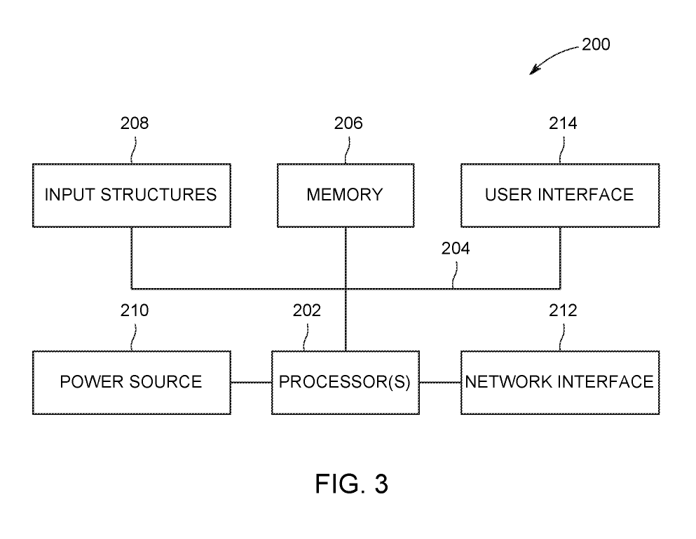

FIG. 3 generally illustrates a block diagram of example components of a computing device 200 that could be used as a remote server 16. As used herein, a computing device 200 may be implemented as one or more computing systems including laptop, notebook, desktop, tablet, or workstation computers, as well as server type devices or portable, communication type devices, such a cellular telephones, and/or other suitable computing devices.

As illustrated, the computing device 200 may include various hardware components, such as one or more processors 202, one or more busses 204, memory 206, input structures 208, a power source 210, a network interface 212, a user interface 214, and/or other computer components useful in performing the functions described herein.

The one or more processors 202 are, in certain implementations, microprocessors configured to execute instructions stored in the memory 206 or other accessible locations. Alternatively, the one or more processors 202 may be implemented as application-specific integrated circuits (ASICs), field-programmable gate arrays (FPGAs), and/or other devices designed to perform functions discussed herein in a dedicated manner. As will be appreciated, multiple processors 202 or processing components may be used to perform functions discussed herein in a distributed or parallel manner.

The memory 206 may encompass any tangible, non-transitory medium for storing data or executable routines, including volatile memory, non-volatile memory, or any combination thereof. Although shown for convenience as a single block in FIG. 3, the memory 206 may actually encompass various discrete media in the same or different physical locations. The one or more processors 202 may access data in the memory 206 via one or more busses 204.

The input structures 208 are used to allow a user to input data and/or commands to the device 200 and may include mice, touchpads, touchscreens, keyboards, and so forth. The power source 210 can be any suitable source for providing power to the various components of the computing device 200, including line and battery power. In the depicted example, the device 200 includes a network interface 212. Such a network interface 212 may allow communication with other devices on a network using one or more communication protocols. In the depicted example, the device 200 includes a user interface 214, such as a display configured to display images or data provided by the one or more processors 202. As will be appreciated, in a real-world context a processor-based systems, such as the computing device 200 of FIG. 3, may be employed to implement some or all of the present approach, such as performing the functions of a remote server 16 shown in FIG. 1 or other processing devices used in the processing and/or streaming of inspection data.

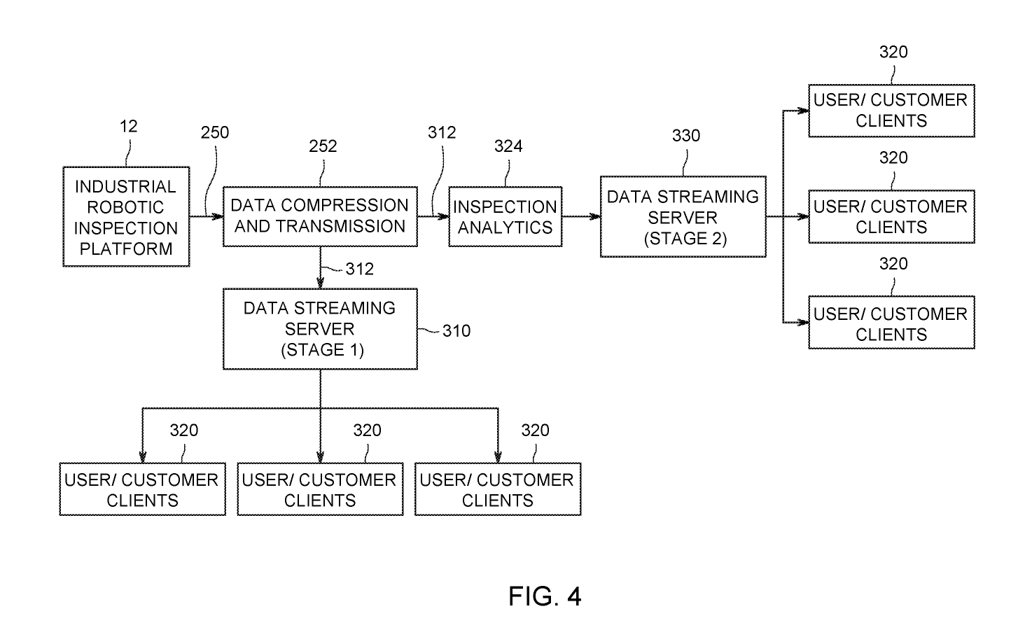

With the preceding in mind, FIG. 4 depicts a system framework in accordance with the present approach. In the depicted framework, an industrial robotic inspection platform is depicted, such as a robot 12 discussed herein. As noted above, the robot 12 can collect multiple types of sensory information 250 relevant to industrial assets, as well as to environmental monitoring, human activities, and so forth. In particular, the robot 12 may be equipped with one or several sensors depending on the different inspection or monitoring requirements or locations. In general, the positions and orientations of the sensors can be adjusted based on one or both of the operator's judgement or the robot's own situational awareness. Sensory information can be collected synchronously or asynchronously. The sensory data 250 collected by the robot(s) 12 may include video data, image data, audio data, laser data, spectroscopic data, environmental data (e.g., temperature, humidity, light levels, inertial measurement data, and so forth.

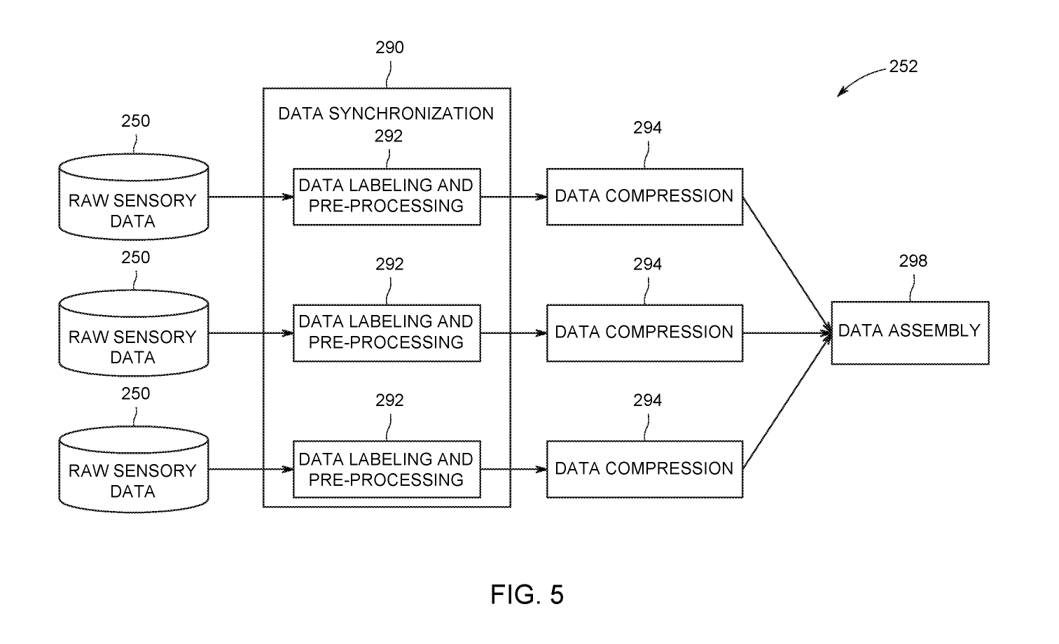

In one embodiment, the collected sensory data 250 is pre-processed (block 252) by the robot 12 and/or a server 16 in communication with the robot 12. As part of pre-processing, redundant data and trash data may be discarded based on defined rules. FIG. 5 depicts one example of an architecture encompassing data pre-processing and compression, as may occur at block 252. In the depicted architecture, various types of raw sensory data 250 are depicted as an input to the architecture. By way of example, the different inputs of raw sensory data 250 may represent the same type of sensory data generated by different robot(s) 12 or platforms, different types of sensory data (e.g., high resolution images and low resolution video; optical images and infrared images, images and spectroscopy data, and so forth) generated by a single robot 12, or some combination of different data types and platforms.

As the raw sensory data 250 may be acquired at different times or at different frame rates or sampling rates, in one implementation a data synchronization (block 290) may be performed such that raw data 250 acquired from different sources (e.g., different robots 12 or platforms) or different sensor types is temporally synchronized or otherwise temporally registered. For example, in one implementation, some or all of the raw data 250 may include time stamps either marking milestone points (e.g., beginning and end of sampling) or acquired continuously with the data. The time stamps may be used to synchronize (i.e., temporally register) different sets of raw sensory data 250. In this manner, each separate set of raw sensor data may be labeled and pre-processed (blocks 292) based on embedded time stamps to allow synchronization.

Some or all of the labeled and pre-processed sensor data may, in the depicted example, undergo compression (blocks 294). With respect to compression, a compression ratio employed at blocks 294 may depend on the data type and/or the importance of the data to a given application. The choice of compression algorithms may also depend on the data type, e.g., video data may be compressed using H.264, image data may be compressed using JPEG format, laser data may be compressed by removing redundancy, inertial measurement unit data may be compressed by grouping first and then removing redundancy, and so forth.

In the depicted example, the synchronized and compressed sensor data may then be combined (data assembly 298) into a single data stream.

Turning back to FIG. 4, in the present embodiment there are two depicted transmission channels flowing from block 252: (1) in a first path, collected sensory data is transmitted, such as either using a wired (e.g., Ethernet cable) or wireless connection to a local workstation (e.g., laptop, desktop, mobile devices, etc.) and/or (2) in a second path, the raw data is broadcast locally for all allowed or subscribed devices to access. The transmitted channel (first path) ensures that the data is received by the workstation robustly and arrives at chronological order. The broadcasting (second path) enables all human operators to receive the data in a real-time, streamed manner.

With respect to the broadcast path, this is shown in FIG. 4 in the context of a raw data streaming server 310 that receives and broadcasts the pre-processed raw data (i.e., unanalyzed data) to users 320 (e.g., reviewers, customers, clients, developers, etc.) who are entitled to the pre-processed raw data 312. The raw data streaming server 310 may broadcast the data in real-time or substantially real-time (i.e., accounting for transmission and pre-processing time as discussed herein). As may be appreciated, a user 320 having access to the real-time stream of data may be able to make decisions or perform actions based on the data that may affect the inspection in real-time. For example, a user having access to control of the robot 12 may be able to assert real-time control of the robot 12 based on what is observed in the streamed data or, absent the availability of such direct control, may be able to request that the robot 12 perform certain actions of an entity that does have control of the robot 12. Similarly, activities such as decision making, human-robot interactions, visualization, and so forth may benefit from the real-time stream of pre-processed raw data.

With respect to the transmitted path, this is shown in FIG. 4 in the context of a transmission data streaming server 330 that receives and transmits one or both of the pre-processed raw data (i.e., unanalyzed data) and/or the inspection analytics (block 330) generated from the pre-processed inspection data to users 320 who have subscribed to or are otherwise entitled to the data. With respect to inspection analytics, such analytics may encompass, but is not limited to annotated sensors data (e.g., annotated image or video data differentially highlighting potential problems or areas needing further inspection or repair, temperature or infrared images or data highlighting operations measured that are out of acceptable bounds, and so forth), inspection reports or summaries, computer assisted diagnostics, and so forth. Such analytics may or may not be part of a package of data to be delivered to a client based on requirements specified by the client or purchased by the client (i.e., a subscription level). That is, depending on a subscription level, some subscribers may receive such analytics while others do not. Further, as noted above, the analytics generated and/or data 250 collected to support such analytics may vary depending on the subscriber base.

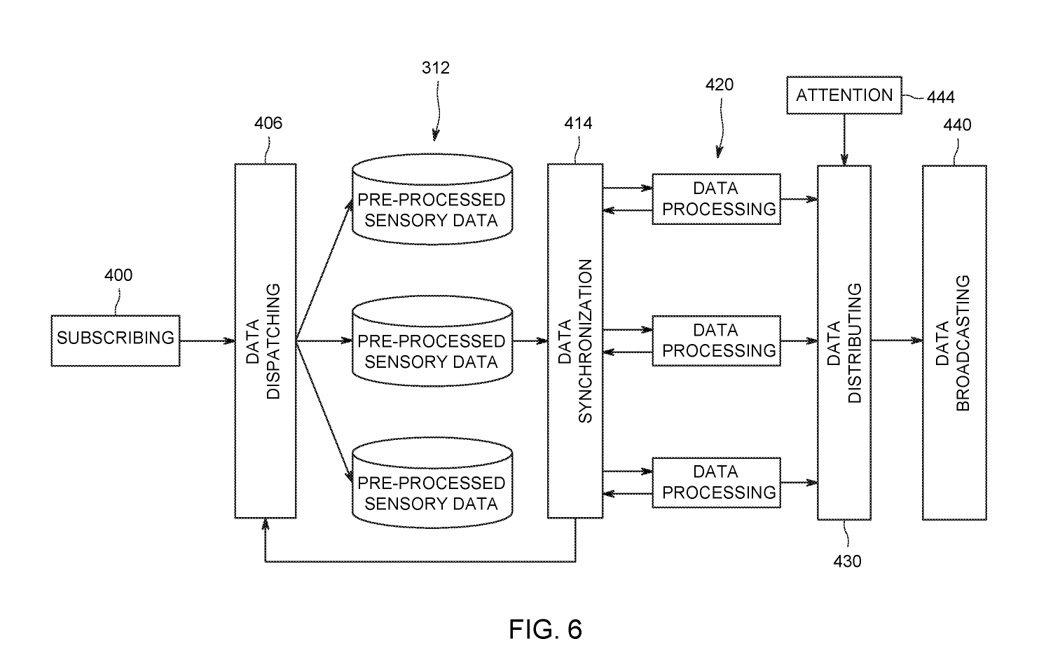

Downstream from the data compression and pre-processing (block 252) and the inspection analytics, the transmission data streaming server 330 is configured to transmit data to users 320 (e.g., subscribers) based on the level of data access or subscription level associated with each user. This is shown in greater detail in FIG. 6 in the context of a publication/subscription architecture, which illustrates aspects of the present approach including: (1) subscribing, (2), data management, (3) synchronized processing, (4) attention-based data distributing, and (5) encrypted data publishing.

With respect to this framework, and referring to FIG. 6, a data subscribing component or aspect 400 obtains the data from data transmission component 252 (i.e., the compressed and assembled data) and or inspection analytics component 324, such as using conventional communication protocols with the data transmission component 252 to ensure the data packet is completed.

The data 312 received by the subscription component may be dispatched (block 406) into different channels for processing (blocks 420). As shown in FIG. 6, the dispatching component 406 is controlled by a data synchronization component 414. As control of dispatching is based on synchronization, not all data 312 will be processed when it is received. Instead, only data needed for distribution (block 430) and broadcasting (block 440) and the data which is already processed by the processing units 420 is dispatched at block 406. This determination may be made by the data synchronization component 414 based on feedback from data processing units 420.

The data synchronization component 414 obtains the data 312 from different channels and sends data to the data processing units 420. The data synchronization component 414 also obtains feedback (e.g., continuous feedback) from the data processing units 420. Based on the feedback, the data synchronization component 414 makes determination, at a given time or time interval, whether to request more data 312 from the dispatching component 406.

In certain implementations or circumstances the data synchronization component does not send such data request signals to the dispatching component 406. In such an implementation, the data synchronization component instead receives data continuously from the channels and instead determines whether the received data 312 is to be sent to the data processing units 420 or not.

The data processing units 420 implement data processing algorithms that are embedded to process the data received from the synchronization component 414. In one embodiment, the data processing algorithms determine what data 312 or aspects of the data 312 are subscribed to by an active or current user 320, which can be used to control the data synchronization and/or data dispatching such that only the data of interest to a current subscriber is received at data processing 420.

Downstream from the data processing components, the data distributing component 430 repackages the data processing results for distribution (i.e., publication) to one or more subscribers. As shown in FIG. 6, an attention component 444 may be provided that allows feedback or instructions (e.g., requests) from a subscriber 320 to be input to the data distributing component 430. In this manner, a given subscriber 320 may provide requests or instructions to the data distributing component 430 to package certain data 312 of interest to the respective subscriber 320 and/or to not package data that is not of interest to the subscriber 320. In accordance with such an approach, computational workload and/or communication traffic may be minimized or otherwise reduced by only providing that data specified or specifically requested by a given subscriber 320.

Further, though the attention mechanism is shown in FIG. 6 as primarily affecting operation of data distribution, in certain implementations such instructions or requests may be propagated further up the processing chain, such as to change or affect data processing, data synchronization, data dispatching, and/or inspection analytics. In certain embodiments, subscriber instructions received in this manner may even change or affect operation of the robot(s) 12, such as to command the acquisition of data at given waypoint or location, of a specific component of an asset being inspected, of a different sensor type, or to limit data from being acquired that is not needed by the subscriber 320. Indeed, even absent an explicit subscriber instruction the robotic inspection system may make determinations as to flight plans, waypoints, sensor acquisitions, and so forth based on the current subscribers 320 to the inspection data so as to improve efficiency of the inspection process by not acquiring data not requested or needed by a current subscriber 320 or to specifically acquire data paid for by a subscriber 320 to the inspection data.

Lastly in FIG. 6, the data packaged in for data distribution (block 430) is broadcast by a data broadcasting component or server that publishes the data on a network or networks for consumption by the subscribers 320. In one implementation, the data is encrypted and only authorized users can access the published data.

Technical effects of the invention include a real-time data streaming system for industrial inspection robots, which aims at providing an innovative solution to: (1) seamlessly automate the data transmission across components; (2) reduce computing workload; (3) provide real-time data; (4) avoid communication jam, and (5) ensure synchronization and data integrity. The present approach provides real-time processing of sensory inspection data on-site and provides seamless transmission pipelines for inspection robotic systems. The present processing result-driven approach reduces the workload on computing and ensures that data can be processed timely. In addition, data can be accessed at different stages of the pipeline. Safe, fast, and encrypted access to data at different stages of the pipeline provides more flexibility on analytics work. The synchronized dispatching and processing reduces the computational requirement placed on computers.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An asset inspection system, comprising:
one or more robots configured to collect inspection data related to an asset; and
a data streaming server configured to receive inspection data from the one or more robots and to transmit subscriber-specific inspection data to one or more subscribers, wherein the data streaming server is configured to:
for one or more subscribers, dispatch an incoming inspection data feed to a plurality of channels;
synchronize the dispatch of the incoming inspection data feed to the plurality of channels based on one or more distribution streams, wherein each distribution stream is specific to at least one subscriber;
process the plurality of channels to generate the one or more distribution streams; and
distribute the one or more distribution streams to the one or more respective subscribers.

2. The asset inspection system of claim 1, wherein the act of dispatching dispatches only that portion of the incoming inspection data feed necessary to generate the one or more distribution streams.

3. The asset inspection system of claim 1, wherein the plurality of channels are processed by one or more data processing components and wherein the one or more data processing components provide instructions controlling the synchronization operation.

4. The asset inspection system of claim 1, wherein the incoming inspection data feed comprises an assembled data stream of compressed and synchronized sensor data acquired by the one or more robots.

5. The asset inspection system of claim 1, wherein the server is further configured to:
receive an instruction from at least one of the one or more subscribers; and
based on the instruction, modify the distribution operation.

6. The asset inspection system of claim 1, wherein the server is further configured to:
receive an instruction from at least one of the one or more subscribers; and
based on the instruction, modify one or more of the synchronization operation, the dispatch operation, or an operation of the one or more robots.

7. The asset inspection system of claim 1, further comprising an additional data streaming server configured to receive inspection data from the one or more robots and broadcast sensor data acquired from the one or more robots in real-time to one or more users.

8. The asset inspection system of claim 8, wherein the broadcast sensor data comprises synchronized and compressed sensor data.

9. The asset inspection system of claim 1, wherein the one or more distribution streams comprise a report or analysis of the inspection data in addition to or in place of the inspection data received from the one or more robots.

10. A method of distributing inspection data or analytics, comprising:
acquiring inspection data related to an asset;
for one or more subscribers, dispatching an incoming inspection data feed derived from the acquired inspection data to a plurality of channels;
synchronizing the dispatch of the incoming inspection data feed to the plurality of channels based on one or more distribution streams, wherein each distribution stream is specific to at least one subscriber;
processing the plurality of channels to generate the one or more distribution streams; and
distributing the one or more distribution streams to the one or more respective sub scribers.

11. The method of claim 10, wherein the act of dispatching dispatches only that portion of the incoming inspection data feed necessary to generate the one or more distribution streams.

12. The method of claim 10, wherein the plurality of channels are processed by one or more data processing components and wherein the one or more data processing components provide instructions controlling the synchronization operation.

13. The method of claim 10, wherein the incoming inspection data feed comprises an assembled data stream of compressed and synchronized sensor data acquired by the one or more robots.

14. The method of claim 10, further comprising the acts of:
receiving an instruction from at least one of the one or more subscribers; and
based on the instruction, modifying the distribution operation.

15. The method of claim 10, further comprising the acts of:
receiving an instruction from at least one of the one or more subscribers; and
based on the instruction, modifying one or more of the synchronization operation, the dispatch operation, or an operation of the one or more robots.

16. The method of claim 10, wherein the one or more distribution streams comprise a report or analysis of the inspection data in addition to or in place of the inspection data received from the one or more robots.

17. An asset inspection system, comprising:
one or more robots configured to collect inspection data related to an asset; and
a data streaming server configured to receive inspection data from the one or more robots and to transmit subscriber-specific inspection data to one or more subscribers, wherein the data streaming server is configured to:
generate one or more client-specific distribution streams based on the inspection data, wherein each client distribution stream comprises one or more of raw data, pre-processed data, processed data, analyzed data, or a summary or annotated report;
receive an instruction from at least one subscriber; and
in response to the instruction, propagate instructions causing a change to the distribution stream for the respective client.

18. The asset inspection system of claim 17, wherein the act of propagating instructions comprises modifying operation of at least one of the one or more robots to cause acquisition of additional sensor data, reduced sensor data, or acquisition of sensor data using one or more additional sensors.

19. The asset inspection system of claim 17, wherein the act of propagating instructions comprises modifying operation of at least one of the one or more robots to cause a change in a flight plan executed the respective robot or robots.

20. The asset inspection system of claim 17, wherein the act of propagating instructions comprises modifying one or more of a data dispatching operation, a data synchronization operation, or a data processing operation used to generate the distribution stream for the respective client.
